(19) United States
(12) Patent Application Publication
(10) Pub. No.: US 2003/0003255 A1
(43) Pub. Date: Jan. 2, 2003

(54) Adhesive-coated display board

(76) Inventor: Jeffrey W. Stover, Cheshire, CT (US)

Correspondence Address: Jeffrey W. Stover, Stover Graphics, P. O. Box 204, Beacon Falls, CT, 06403, US

(21) Appl. No.: 10/178,367

(22) Filed: Jun. 25, 2002

Related U.S. Application Data
(60) Provisional application No. 60/301,027, filed on Jun. 27, 2001.

(51) Int. Cl. B32B 9/00

(52) U.S. Cl. 428/40.1; 428/194

(57) ABSTRACT

A display board having a perimeter and adapted to mount a sheet bearing artwork, the board having a central area, the boundaries of which are spaced on all sides inward from the perimeter, and a layer of adhesive in the central area. The central area and adhesive is covered by a protective layer removably adhered to the area by the adhesive. The area may be defined by a depressed line in the board.

### FIELD OF THE INVENTION

This invention relates to display boards used for mounting photographs, prints, crafts, documents, projects, and other items. More specifically, this invention relates to such a board which is pre-coated with a pressure-sensitive adhesive.

### BACKGROUND OF THE INVENTION

It is often desired to mount a print or the like in a central position on a larger mat board. This allows the border to be used in handling the work and in marking the mat without affecting the print. More importantly, the centering enhances the presentation by creating a frame around the print. At present this is done in a series of separate steps and requires careful measurement and alignment of the print in the center of the board.

Under the present invention a mat is provided that has a central adhesive coated area inward from the periphery on all sides. The area may be sized to accommodate precisely the precise dimension of popular photo prints, i.e., 5×7, 8×10, etc. The area, before mounting of the print, is covered by a peel sheet and for further enhancement the central area is defined by a depressed margin line imparted by a “kiss cut” of a steel rule die.

### SUMMARY OF THE INVENTION

The invention is a display board having a perimeter and adapted to mount a sheet bearing artwork, the board having a central area, the boundaries of which are spaced on all sides inward from the perimeter, and a layer of adhesive in the central area. The central area and adhesive is covered by a protective layer removably adhered to the area by the adhesive. The area may be defined by a depressed line in the board.

### BRIEF DESCRIPTION OF THE DRAWINGS

Further objects and features of the invention will be clear to those skilled in the art from a review of the following specification and attached drawings, all of which present a non-limiting form of the invention. In the drawings:

FIG. 1 is a top view of a board embodying the invention showing the protective layer partly peeled off to reveal the adhesive, and

FIG. 2 is an enlarged fragmentary sectional view taken on the line 2-2 of FIG. 1.

### DESCRIPTION OF THE PREFERRED EMBODIMENT

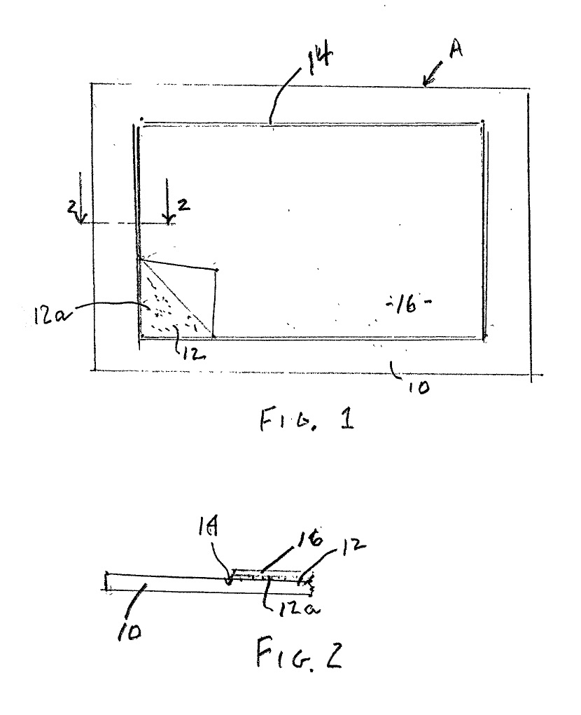

A display board embodying the invention is shown in FIG. 1 and generally designated A. It comprises a mat board 10 having a central area 12 covered with adhesive 12a. The central area is preferably defined by a depressed continuous line 14 surrounding that area.

A cover sheet 16 of silicon or the like covers the central area 12 and the adhesive 12a adhered thereto.

In use, once the protective layer (i.e. the silicon sheet) is removed, the artwork, print, etc. of the size for the selected board, is pressed against the adhesive-coated surface. Then, the user can handle the mounted print or display it in any manner he chooses.

The invention uses standard existing display boards such as mat boards, foam boards and other items which can used with easels, frames, magnets as is typically found in graphic display. The use of adhesives is common to insure that prints are kept in place and flat on the board. This is important for viewing and the aesthetic presentation. These components are commonly found in products which display photographs, artwork, presentations and the like.

The coating of adhesive and print only in the interior of the board accomplishes the “framed look” without any complicated steps or items required. It also insures the intended placement of the print, such as in the center of the board, without the need for extra steps to calculate such placement. It also allows the edges of the board to be used for other purposes including identifying markings and titles, shapes to resemble items related to the print displayed (such as the board may be cut in the shape of a ball to display a sports theme).

To accomplish this, the adhesive must be placed by design on the board where intended. This can be done by methods such as screen-printing the adhesive on the boards. Any protective paper over the adhesive must be similarly designed and overlaid in the same position.

The adhesive must have enough viscosity such that a sufficient amount of the adhesive lies on top of the board and can bond to the print. The degree of viscosity, porosity of the display board and the thickness of the coating must be determined for each type of board. The thickness of the coating can be precisely determined by the design of the screens through which the adhesive is coated onto the board. The screen also positions the adhesive precisely on the board being coated. The adhesive must be porous enough to fit through the screen and thick enough not to soak through the board.

Variations in the invention are contemplated. While the invention has been disclosed in only one embodiment, it is not so limited but is of a scope defined by the following claim language which may be broadened by an extension of the right to exclude others from making, using or selling the invention as is appropriate under the doctrine of equivalents.

What is claimed is:

1. A display board having a perimeter and adapted to mount a sheet of artwork, the board having a central area, the boundaries of which are spaced on all sides inward from the perimeter, a layer of adhesive coating covering only the central area.

2. A display board as claimed in claim 1 wherein the central area is covered by a protective sheet adhered to the area by the adhesive and readily removable by peeling.

3. A display board as claimed in claim 1 wherein the central area is defined by a depressed line in the board.
